(19) United States
(12) Patent Application Publication
(10) Pub. No.: US 2004/0178679 A1
(43) Pub. Date: Sep. 16, 2004

(54) Uninterruptible power supply

(75) Inventor: Takashi Kabasawa, Maebashi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Sanyo Electric Co., Ltd., Moriguchi-shi (JP)

(21) Appl. No.: 10/792,892

(22) Filed: Mar. 5, 2004

(30) Foreign Application Priority Data
Mar. 13, 2003 (JP) 2003-068705

(51) Int. Cl. B60L 1/00

(52) U.S. Cl. 307/10.1

(57) ABSTRACT

An uninterruptible power supply comprises a rechargeable battery, such as a Li-ion battery and a Ni-MH battery, and is suitable for installation in electronic apparatus, such as a personal computer. The uninterruptible power supply appraises an operating state of a main body of the electronic apparatus on the basis of an output state of first DC power (standby power) necessary for standby operation of the main body and second DC power (operating power) necessary for normal operation of the main body, that are produced by a power supply unit, or on the basis of a power loading dose of the power supply unit, and supplies backup power to the main body only when the main body is in normal operation.

This Nonprovisional application claims priority under 35 U.S.C. § 119(a) on Patent Application No. 2003-68705 filed on Mar. 13, 2003, the entire contents of which are hereby incorporated by reference.

### BACKGROUND OF THE INVENTION

1. Field of the Invention

The present invention relates to an uninterruptible power supply suitable for installation in electronic apparatus, such as a computer, and for use as a backup power source at the time of a power failure in an alternator.

2. Description of the Prior Art

When a momentary power failure or the like occurs in the middle of operation of electronic apparatus, such as a personal computer and a server, using a commercial power source (alternator) as an electric power source, there arises such problems as that an error occurs in the processing operation of the electronic apparatus and that important processing data is damaged. To avoid such problems, for instance, Unexamined Japanese Patent Application Publication Nos. 2002-27683 and 2002-258993 teach installing an uninterruptible power supply (battery pack) including a rechargeable battery as a main body in electronic apparatus of the aforementioned type.

In electronic apparatus such as a personal computer, for instance, in cases where the processing operation thereof is at a standstill over a given period of time, power savings are attempted by stopping the power supply necessary for normal operation of the main body of the electronic apparatus and supplying electric power exclusively to certain circuit portions that implement standby operation. For reference's sake, the above-mentioned circuit portions that carry out standby operation act for detecting the information provided through an input device such as keyboards, canceling the standby state (standby operation) of the main body of the electronic apparatus, and then restoring the main body to normal operation, when the main body is in a standby state.

A conventional uninterruptible power supply (battery pack) installed in electronic apparatus of the aforementioned type is constructed in a way that the backup function thereof is activated solely on the condition that it is connected to a power supply unit of the electronic apparatus. The uninterruptible power supply monitors the input state of an alternator to the power supply unit. When a power failure is detected, the uninterruptible power supply operates so that the electric power energy stored in the rechargeable battery is supplied through the power supply unit to the main body of the electronic apparatus.

More specifically, a conventional uninterruptible power supply constantly monitors the input of the alternator to the power supply unit, whether or not the electronic apparatus is at a standstill, whether or not in the standby state (standby operation), and whether or not in normal operation. In addition, the uninterruptible power supply is so designed that backup power is provided from the battery pack to the main body of the electronic apparatus when the alternator is turned off by a power failure even if the main body is in the standby state (standby operation) and is not in normal operation. This causes a problem that there is much waste of power in the uninterruptible power supply.

### SUMMARY OF THE INVENTION

An object of the present invention is to provide a highly practical uninterruptible power supply capable of properly supplying backup power to a main body of electronic apparatus according to an operating state of the main body and eliminating a waste of power.

More specifically, the object of the invention is to provide an uninterruptible power supply in which power savings are attempted by supplying the backup power to the main body of the electronic apparatus at the time of a power failure in an alternator only when the main body is in normal operation or deactivating a backup function thereof when the main body is at a standstill or in standby operation.

To achieve this object, the uninterruptible power supply according to the present invention is installed in electronic apparatus having a main body that implements given processing operation and a power supply unit that produces direct current power (hereinafter referred to as DC power) necessary for the operation of the main body from an alternator and supplies the DC power to the main body according to an operating state of the main body, the uninterruptible power supply comprising a rechargeable battery that is charged by receiving the DC power produced by the power supply unit and backup function-controlling means for activating a function of the rechargeable battery as a backup power source for the main body at the time of a power failure in the alternator if the main body is provided with the DC power and deactivating the function of the rechargeable battery as the backup power source if the main body is not provided with the DC power.

Another interruptible power supply according to the present invention comprises backup function-controlling means that detects a power loading dose of the power supply unit, judges whether the main body of the electronic apparatus is in a standby state or in a operating state. When determining that the main body is in a standby state, the backup function-controlling means deactivates the function as a backup power source for the electronic apparatus using the rechargeable battery.

With the uninterruptible power supply according to this invention, a judgement is made as to an operating state of the main body of the electronic apparatus from an output state of first DC power VS and second DC power VDC of the power supply unit that creates DC power from the alternator and provides the power to the main body or from a power loading state of the power supply unit with respect to the main body. Based on the result of the judgement, the supply of the backup power to the main body is controlled. This makes it possible to eliminate unproductive operation in the uninterruptible power supply (battery pack) during the main body is in a standby state or at a standstill and to then avoid a waste of power. Additionally, the operating state of the main body can be reliably detected from that of the power supply unit without difficulty. As a consequence, the present invention brings about a practically significant effect, such as of satisfactorily enhancing the operational reliability of the uninterruptible power supply.

### BRIEF DESCRIPTION OF THE DRAWINGS

The present invention will become more fully understood from the detailed description given herein below and the accompanying drawings which are given by way of illustration only, and thus, are not limitative of the present invention, and wherein:

FIG. 1 is a view showing connection between an uninterruptible power supply and a power supply unit of electronic apparatus according to one embodiment of the present invention;

FIG. 2 is a view showing an example of the steps of judging operation of a main body of the electronic apparatus in the uninterruptible power supply of FIG. 1; and

FIG. 3 is a view showing another example of the steps of judging the operation of the main body of the electronic apparatus in the uninterruptible power supply of FIG. 1.

### DETAILED DESCRIPTION OF THE INVENTION

An uninterruptible power supply according to one embodiment of the present invention will be described below with reference to the drawings.

The uninterruptible power supply is suitable for installation in electronic apparatus, such as a personal computer, that implements a given process using a commercial power source (alternator) as an electric power source to assure actuation of a main body of the electronic apparatus when the commercial power source is turned off by a power failure. Specifically, the uninterruptible power supply is utilized after being connected to a power supply unit in the electronic apparatus and includes a rechargeable battery, such as a Li-ion battery and a Ni-MH battery. The uninterruptible power supply is so constructed as to receive DC power created by the power supply unit to charge the rechargeable battery and provide electric power energy stored in the rechargeable battery through the power supply unit to the main body of the electronic apparatus at the time of a power failure in the commercial power source (alternator). Due to the supply of the electric power energy from the rechargeable battery, the rechargeable battery serves as a backup power source that assures the actuation of the main body.

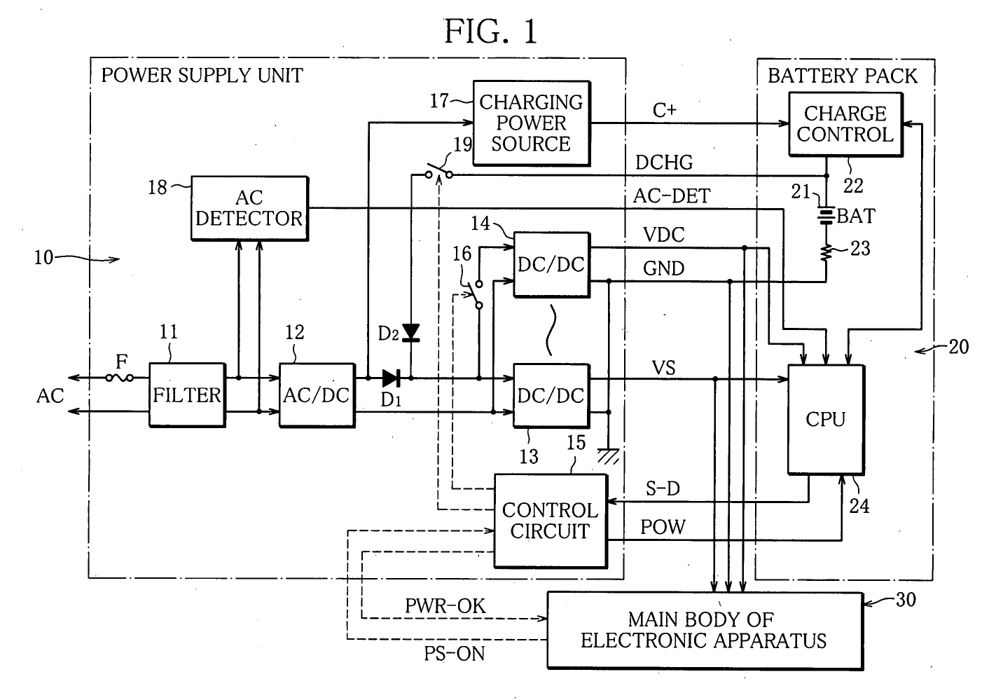

A power supply unit 10 of the main body of the electronic apparatus and an uninterruptible power supply (battery pack) 20 according to the present embodiment will be described with reference to FIG. 1. The power supply unit 10 of the main body basically inputs a commercial power source of an alternating current (AC) through a filter 11 and produces DC power through an AC/DC converter 12. The uninterruptible power supply 20 is so constructed as to generate plural kinds of DC powers, for example, with different voltages, that are to be supplied to a main body 30 of the electronic apparatus, from the DC power through DC/DC converters 13 and 14.

The first DC/DC converter 13 produces first DC power (standby power) VS necessary for standby operation of the main body 30 when a power switch (not shown) disposed in the main body 30 is turned on and steadily provides the first DC power VS to the main body 30. The first DC power (standby power) VS is outputted regardless of an after-mentioned power supply-ON terminal signal and provided to a circuit that needs to be powered even in a standby state. The second DC/DC converter 14 creates second DC power (operating power) VDC necessary for normal operation of the main body 30 according to an operating state of the main body 30 and provides the second DC power VDC to the main body 30. More specifically, the second DC/DC converter 14 is actuated by receiving the DC power from the AC/DC converter 12 through a switch 16 that is turned on/off in response to control of a control circuit 15. The second DC/DC converter 14 is so constructed as to provide power to the main body 30 only when the switch 16 is on.

The control circuit 15 deactivates the second DC/DC converter 14 by turning off the switch 16, for instance, when the main body 30 is at a standstill over a given period of time. The deactivation of the second DC/DC converter 14 stops the supply of the second DC power (operating power) VDC from the second DC/DC converter 14 to the main body 30. Due to the suspension of output of the second DC power (operating power) VDC, it is possible to avoid a waste of power in the main body 30 by bringing the main body 30 into a standby state.

In such a state, the power supply unit 10 provides the main body 30 only with the first DC power (standby power) VS. Thus, the main body 30 receives only the first DC power (standby power) VS to perform standby operation. As illustrated in FIG. 1, the control circuit 15 has a power supply-ON terminal serving as a terminal that communicates the information as to whether the main body 30 is at a halt or in the standby state to the power supply unit 10. By setting the power supply-ON terminal signal at a high level, the main body 30 is provided only with the first DC power (standby power) VS from the power supply unit 10. On the contrary, if a command to maintain the power supply-ON terminal signal at a common level (0V) is given by the main body 30 side, the power supply unit 10 provides the second DC power VDC to the main body 30.

In the control circuit 15, when the output from the power supply unit 10 to the main body 30 ramps up to approximately 95 percent of a rated voltage, a high-level signal is outputted from another terminal denoted by PWR-OK in FIG. 1. The main body 30 monitors the high-level PWR-OK signal and judges whether the power is supplied in a correct manner.

At the same time, the control circuit 15 monitors the operation of an input device, such as keyboards and a mouse. When the main body 30 is given any operation command through the input device and the like while in the standby state, the control circuit 15 detects this command and turns on the switch 16 to activate the second DC/DC converter 14. Recommencing the supply of the second DC power from the second DC/DC converter 14 to the main body 30 restores the main body 30 to the normal operation state.

Besides such basic functions, the power supply unit 10 has a charging power source 17 for generating DC power C+ for charging the rechargeable battery for the uninterruptible power supply (battery pack) 20 and an alternating current detector (AC detector) 18 for monitoring the input of the alternator. The AC detector 18 has a function of checking the input of AC power, or AC power interruption, by monitoring the AC power applied through a filter 11 to the AC/DC converter 12. While the AC power is inputted, the AC detector 18 detects the input and outputs a given AC detection signal AC-DET.

The uninterruptible power supply (battery pack) 20 that is connected to the power supply unit 10 and utilized as a backup power source for the main body 30 includes a rechargeable battery (BAT) 21, such as a Li-ion battery and a Ni-MH battery, as illustrated in FIG. 1. The rechargeable battery 21 is connected to a charging output terminal C+ of the charging power source 17 with a charge control circuit 22 therebetween, for example, at a positive terminal thereof and grounded by a shunt resistor 23 at a negative terminal thereof. The rechargeable battery 21 is so disposed as to be chargeable through the charging power source 17. The ground of the rechargeable battery 21 through the shunt resistor 23 is carried out through the power supply unit 10. Due to such ground of the rechargeable battery 21 through the power supply 10, the rechargeable battery 21 is charged only when each terminal of the uninterruptible power supply (battery pack) 20 is connected to the power supply unit 10 without fail.

The positive terminal of the rechargeable battery 21 is connected not only to the charging output terminal C+ as described above but to the power supply unit 10 through a discharging power line DCHG. Moreover, the positive terminal of the rechargeable battery 21 is connected to a DC power supply line of the power supply unit 10 serially through a switch 19 and a diode D2 located in the power supply unit 10. The switch 19 is conducted under control of the control circuit 15 when the input of the AC power is stopped (interrupted). Due to the conduct of the switch 19, the electric power energy stored in the rechargeable battery 21 is discharged and supplied to the power supply unit 10. The electric power energy (DC power) discharged from the rechargeable battery 21 is supplied to the first and second DC/DC converters 13 and 14, and provided through the DC/DC converters 13 and 14 to the main body 30 as the first DC power (standby power) VS and the second DC power (operating power) VDC, respectively.

The diode D2 serves to prevent the discharge current from the rechargeable battery 21 from flowing to the charging power source 17 in consort with the diode D1 located in between the AC/DC converter 12 and the first and second DC/DC converters 13 and 14. The diode D2 also serves to keep the rechargeable battery 21 from being directly charged by receiving the DC power generated by the AC/DC converter 12. Even if the switch 19 is turned on by accident in spite that no power failure occurs, the diode D2 makes it possible to charge the rechargeable battery 21 only through the charge control circuit 22. Consequently, since the charge of the rechargeable battery 21 is controlled by the charge control circuit 22, overcharge of the rechargeable battery 21 is prevented from occurring.

A central processing unit (CPU) 24 including backup function-controlling means incorporated into the uninterruptible power supply (battery pack) 20 basically detects the actuating state of the power supply unit 10 and controls the actuation of the uninterruptible power supply (battery pack) 20. The CPU 24 primarily monitors information as to the charging state of the rechargeable battery 21, the information being supplied by the charge control circuit 22, the input state (power failure information) of the AC power source that is presented by the AC detector 18 of the power supply unit 10, etc. When the input of the AC power source is stopped (interrupted) in the middle of the operation (service) of the main body 30 by turning on the switch, the CPU 24 outputs a signal S-D indicating that power can be supplied from the rechargeable battery 21 to the control circuit 15. In response to the signal S-D, the control circuit 15 turns on the switch 19 to cause the rechargeable battery 21 to discharge the stored electric power energy. This makes the battery pack (rechargeable battery 21) function as a backup power source for the main body 30 at the time of a power failure in the AC power source.

The uninterruptible power supply (battery pack) 20 according to the present invention, which is basically constructed as described above, is characterized in that the CPU 24 monitors the output of the first DC power (standby power) VS and the second DC power (operating power) VDC, which are created by the first and second DC/DC converters 13 and 14, respectively, and that the CPU 24 also monitors a signal POW indicating a power loading state of the power supply unit 10, that is checked by the control circuit 15. The CPU 24 controls the supply of the backup power from the rechargeable battery 21 to the main body 30 as described below according to supplying conditions of the DC powers VS and VDC to the main body 30 or the power loading state of the power supply unit 10.

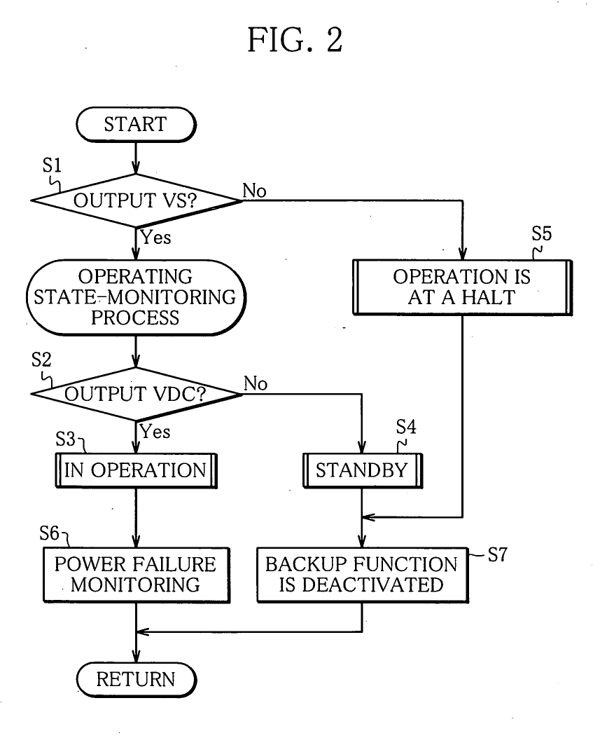

More specifically, the CPU 24 judges whether the power supply unit 10 outputs the first DC power VS to the main body 30, for example, as illustrated in FIG. 2 <step S1> and then judges whether the power supply unit 10 outputs the second DC power VDC <step S2>. If the power supply unit 10 outputs the second DC power VDC to the main body 30, the CPU 24 determines that the main body 30 is in normal operation <step S3>. If the power supply unit 10 does not output the second DC power VDC to the main body 30 and merely supplies the first DC power VS thereto, the CPU 24 determines that the main body 30 is in standby operation <step S4>. In cases where the first DC power VS is not outputted by the power supply unit 10, the CPU 24 determines that the power switch is off and that the main body 30 is at a halt <step S5>.

The CPU 24 in the battery pack 20 activates the backup function if the main body 30 is in normal operation. In this state, the CPU 24 monitors the input of an AC signal on the basis of the AC detection signal AC-DET <step S6> and outputs the signal S-D to the power supply unit 10 only when detecting interruption of the input of the AC signal. Then, the CPU 24 causes the electric power energy stored in the rechargeable battery 21 to be discharged as a backup power source for the main body 30. On the other hand, if the main body 30 is in standby operation or at a standstill, the CPU 24 stops monitoring the AC detection signal AC-DET and deactivates the backup function itself with respect to the main body 30 <step S7>. In the state where the backup function is at a standstill, the power supply from the rechargeable battery 21 to the power supply unit 10 is stopped in response to a signal from the CPU 24.

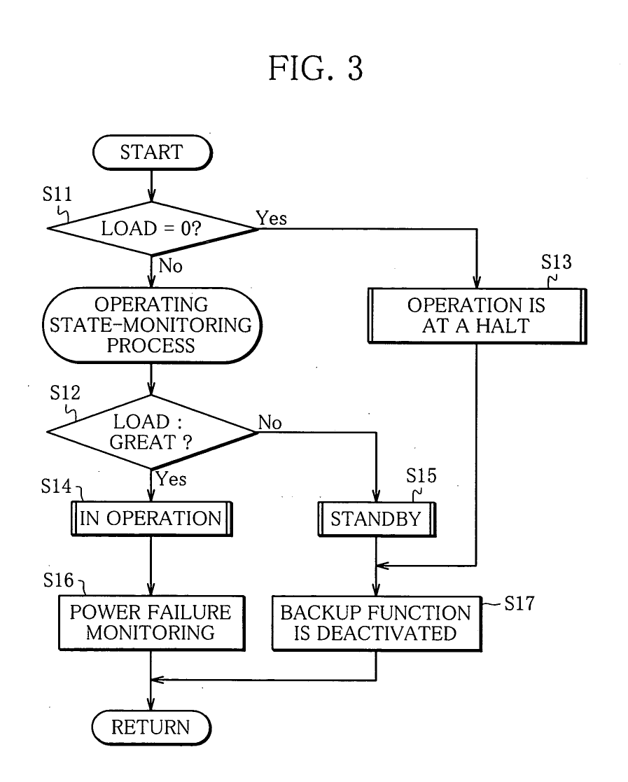

The CPU 24 may be designed to check the signal POW indicating the power loading state of the power supply unit 10 and control the backup function. In this case, the CPU 24 judges whether or not the power load of the power supply unit 10 is “0” from the presence of the signal POW, for instance, as shown in FIG. 3 <step S11>. In the case that a power load is present in the power supply unit 10, the CPU 24 judges whether the power load is greater than a preset determination level <step S12>.

If the power load in the power supply unit 10 is “0”, the CPU 24 determines that the power switch is off and that the main body 30 is at a standstill <step S13>. If the power load in the power supply unit 10 is great, the CPU 24 determines that the main body 30 is in normal operation <step S14>. On the contrary, if the power load is small, the CPU 24 determines that the main body 30 is in standby operation <step S15>. Furthermore, the CPU 24 activates the backup function only when detecting that the main body 30 is in normal operation <step S16>. Only if the supply interruption of the AC power is detected, the CPU 24 causes the electric power energy stored in the rechargeable battery 21 to be discharged as a backup power source for the main body 30 as described above. In cases where the main body 30 is in standby operation or at a standstill, the backup function is deactivated <step S17>. The CPU 24 herein includes power load-determining means as is obvious from the above descriptions.

According to the uninterruptible power supply (battery pack) having the function of detecting the output state of the first and second DC powers VS and VDC with respect to the main body 30 in the power supply unit 10 or the power loading state POW of the power supply unit 10 with respect to the main body 30 and judging whether the main body 30 is in normal operation or in standby operation or at a standstill, the backup function can be activated only if the main body 30 is in normal operation. When the main body 30 is in standby operation or at a standstill, the backup power is not particularly provided from the battery pack to the main body 30 even if the input of the AC power is interrupted.

As a consequence, only when it is truly required to supply the backup power to the main body 30 in order to assure the operating state at the time of a power failure in the AC power source, the battery pack 20 is activated according to the operating state of the main body 30, making it possible to reduce loads in the battery pack 20. Furthermore, since the operating state of the main body 30 is monitored from that of the power supply unit 10 with the primary function of the power supply unit 10 fully utilized, the structure of the uninterruptible power supply is not complicated, and the operating state of the main body 30 can be reliably determined without difficulty. As a result, it is possible to avoid unnecessary backup operation while operational reliability is fully assured. It is also possible to reduce power consumption in the battery pack 20 and to therefore reduce power consumption in the whole electronic apparatus in which the battery pack 20 is installed.

The present invention is not limited to the aforementioned embodiments. For instance, concerning the charge controlling method with respect to the battery pack 20 under the charge control circuit 22, various methods which have been proposed may be properly applied instead. The CPU 24 has only to be constructed to power the main body 30 as described only when the rechargeable battery 21 stores electric power energy enough to function as a backup power source. Furthermore, the CPU 24 may be designed to detect either the output state of the first and second DC powers VS and VDC to the main body 30 or the power loading state POW of the power supply unit 10 with respect to the main body 30. In addition, various modifications can be made without deviating from the gist of the invention.

What is claimed is:

1. An uninterruptible power supply installed in electronic apparatus having:
a main body that implements given processing operation; and
a power supply unit for generating DC power necessary for normal operation of the main body from an AC power source and supplying the DC power to the main body according to an operating state of the main body, the uninterruptible power supply comprising:
a rechargeable battery that is charged by receiving the DC power generated by the power supply unit; and
backup function-controlling means for activating a function of the rechargeable battery as a backup power source for the main body at the time of a power failure in the AC power source when the main body is supplied with the DC power and deactivating the function of the rechargeable battery as the backup power source when the main body is not supplied with the DC power.

2. An uninterruptible power supply installed in electronic apparatus having:
a main body that implements given processing operation; and
a power supply unit for generating first DC power necessary for standby operation of the main body and second DC power necessary for normal operation from an AC power source, steadily supplying the first DC power to the main body, and supplying the second DC power to the main body according to an operating state of the main body, the uninterruptible power supply comprising:
a rechargeable battery that is charged by receiving the second DC power; and
backup function-controlling means for activating a function of the rechargeable battery as a backup power source for the main body at the time of a power failure in the AC power source when the main body is supplied with the second DC power and deactivating the function of the rechargeable battery as the backup power source when the supply of the second DC power to the main body is at a halt.

3. The uninterruptible power supply according to claim 1 or 2, wherein:
the backup function-controlling means includes a switch element located in the middle of a discharge channel of the rechargeable battery to interdict a discharge of the rechargeable battery.

4. An uninterruptible power supply installed in electronic apparatus having:
a main body that implements given processing operation; and
a power supply unit for controlling supply of DC power generated from an AC power source to the main body, the uninterruptible power supply comprising:
a rechargeable battery that is charged by receiving DC power produced by the power supply unit and used as a backup power source for the main body at the time of a power failure in the AC power source;
power loading dose-determining means for judging whether the main body is in a standby state or operating state from a power loading dose of the power supply unit; and
backup function-controlling means for deactivating a function of the rechargeable battery as the backup power source when the main body is in the standby state.

5. The uninterruptible power supply according to claim 4, wherein:
the backup function-controlling means includes a switch element located in the middle of a discharge channel of the rechargeable battery to interdict a discharge of the rechargeable battery.
